(19) United States
(12) Patent Application Publication
(10) Pub. No.: US 2009/0222613 A1
(43) Pub. Date: Sep. 3, 2009

(54) INFORMATION PROCESSING APPARATUS AND NONVOLATILE SEMICONDUCTOR MEMORY DRIVE

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/390,236

(22) Filed: Feb. 20, 2009

Related U.S. Application Data
(63) Continuation of application No. PCT/JP2008/070722, filed on Nov. 7, 2008.

(30) Foreign Application Priority Data
Feb. 29, 2008 (JP) 2008-050810

(51) Int. Cl. G06F 12/02; G06F 12/00

(52) U.S. Cl. 711/103; 711/200; 711/202; 711/E12.001; 711/E12.008

(57) ABSTRACT

According to one embodiment, an information processing apparatus includes an information processing apparatus main body, and a nonvolatile semiconductor memory drive which is accommodated in the information processing apparatus main body. The nonvolatile semiconductor memory drive includes a nonvolatile semiconductor memory, an address management table which is indicative of a correspondency between logical block addresses and physical addresses of the nonvolatile semiconductor memory, and a control module. The control module refers to the address management table in response to reception of a read request from the information processing apparatus main body, and outputs data of a predetermined value to the information processing apparatus main body in a case where the physical address corresponding to the logical block address, which is included in the read request, is not stored in the address management table.

### CROSS REFERENCE TO RELATED APPLICATIONS

This is a Continuation Application of PCT Application No. PCT/JP2008/070722, filed Nov. 7, 2008, which was published under PCT Article 21(2) in English.

This application is based upon and claims the benefit of priority from Japanese Patent Application No. 2008-050810, filed Feb. 29, 2008, the entire contents of which are incorporated herein by reference.

### BACKGROUND

1. Field

One embodiment of the invention relates to an information processing apparatus and a nonvolatile semiconductor memory drive.

2. Description of the Related Art

As a device for managing a nonvolatile semiconductor memory, there is known a memory management device which is disclosed, for example, in Jpn. Pat. Appln. KOKAI Publication No. 2006-79543.

This memory management device returns an initial value to a host in the case where a read request is issued from the host with respect to a memory unit for which an erase request has been issued from the host.

Specifically, this nonvolatile semiconductor memory management device includes a nonvolatile semiconductor memory having a logical/physical address conversion table, and a control unit which refers to the logical/physical address conversion table in response to a data erase request from the host, and stores, as a virtual erase area, a physical block address which is associated with a logical block that is designated by the erase request. In the case where a read request for data included in the virtual erase area is issued from the host, the control unit returns an initial value to the host. Accordingly, without actually erasing the data in the nonvolatile semiconductor memory, the host can be made to recognize as if data erase has been executed. Thus, the process time for data erase can be reduced.

In this memory management device, however, since a process of initializing the nonvolatile semiconductor memory, in which no initial value data is written in each memory unit, is performed at the time of shipment, it is necessary to perform a fabrication step of erasing all data (a step of storing all physical block addresses as virtual erase areas), leading to an increase in the number of fabrication steps. It is thus required to realize a novel function for omitting a step of an initializing process at a time of manufacture.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the Invention.

FIG. 1 is a perspective view showing the external appearance of an information processing apparatus according to an embodiment of the present invention;

FIG. 2 is a block diagram which schematically shows the structure of the information processing apparatus according to the embodiment;

FIG. 3 is a block diagram which schematically shows the structure of an SSD that is used in the information processing apparatus according to the embodiment;

FIG. 4 schematically shows the memory capacities and memory areas of the SSD which is used in the information processing apparatus according to the embodiment;

FIG. 5 shows an example of the structure of a flash address conversion table which is used in the information processing apparatus according to the embodiment; and

FIG. 6 is a flow chart illustrating the operation of the SSD which is used in the information processing apparatus according to the embodiment.

### DETAILED DESCRIPTION

Various embodiments according to the invention will be described hereinafter with reference to the accompanying drawings. In general, according to one embodiment of the invention, there is provided an information processing apparatus comprising: an information processing apparatus main body; and a nonvolatile semiconductor memory drive which is accommodated in the information processing apparatus main body, the nonvolatile semiconductor memory drive including a nonvolatile semiconductor memory, an address management table which is indicative of a correspondency between logical block addresses and physical addresses of the nonvolatile semiconductor memory, and a control module, the control module referring to the address management table in response to reception of a read request from the information processing apparatus main body, and outputting data of a predetermined value to the information processing apparatus main body in a case where the physical address corresponding to the logical block address, which is included in the read request, is not stored in the address management table.

According to the information processing apparatus, in a case where a read request, which designates a logical block address, a corresponding physical address of which is not stored, is issued, data of a predetermined value is output to the information processing apparatus main body. Therefore, a step of an initializing process at a time of manufacture can be omitted.

<Structure of Information Processing Apparatus>

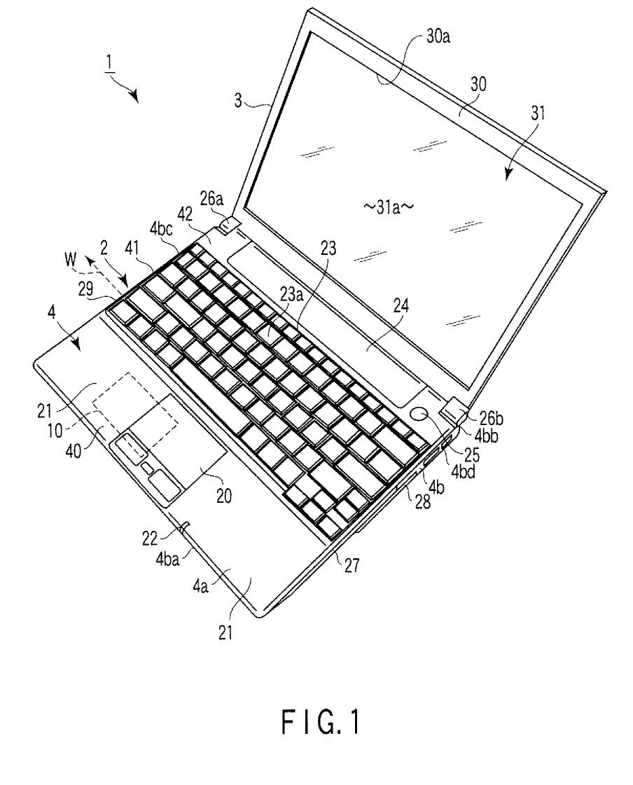

FIG. 1 is a perspective view showing the external appearance of an information processing apparatus according to an embodiment of the present invention.

This information processing apparatus 1 is composed of an information processing apparatus main body 2 and a display unit 3 which is attached to the information processing apparatus main body 2.

The main body 2 has a box-shaped casing 4. The casing 4 includes an upper wall 4a, a peripheral wall 4b and a lower wall (not shown). The upper wall 4a of the casing 4 includes a front part 40, a central part 41 and a back part 42 in the named order from the side close to a user who operates the information processing apparatus 1. The lower wall is opposed to an installation surface on which the information processing apparatus 1 is disposed. The peripheral wall 4b includes a front wall 4ba, a rear wall 4bb and left and right side walls 4bc and 4bd.

The front part 40 includes a touch pad 20 which is a pointing device, a palm rest 21, and an TED 22 which is turned on in association with the operation of respective parts of the information processing apparatus 1.

The central part 41 includes a keyboard mounting part 23 to which a keyboard 23a, which can input character Information, etc., is attached.

The back part 42 includes a battery pack 24 which is detachably attached. A power switch 25 for powering on the information processing apparatus 1 is provided on the right side of the battery pack 24. A pair of hinge portions 26a and 26b, which rotatably support the display unit 3, are provided on the left and right sides of the battery pack 24.

An exhaust port 29 for exhausting the wind W to the outside from the inside of the casing 4, is provided on the left side wall 4bc of the casing 4. In addition, an ODD (Optical Disc Drive) 27, which can read and write data on an optical storage medium such as a DVD, and a card slot 28, in/from which various cards can be inserted/taken out, are disposed on the right side wall 4bd.

The casing 4 is formed of a casing cover including a part of the peripheral wall 4b and the upper wall 4a, and a casing base including a part of the peripheral wall 4b and the lower wall. The casing cover is detachably coupled to the casing base, and an accommodation space is formed between the casing cover and the casing base. This accommodation space accommodates, for instance, an SSD (Solid State Drive) 10 functioning as a nonvolatile semiconductor memory drive. The details of the SSD 10 will be described later.

The display unit 3 includes a display housing 30 having an opening portion 30a, and a display device 31 which is composed of, e.g. an LCD which can display an image on a display screen 31a. The display device 31 is accommodated in the display housing 30, and the display screen 31a is exposed to the outside of the display housing 30 through the opening portion 30a.

The casing 4 accommodates a main circuit board, an expansion module, a fan, etc., which are not shown, in addition to the above-described SSD 10, battery pack 24, ODD 27 and card slot 28.

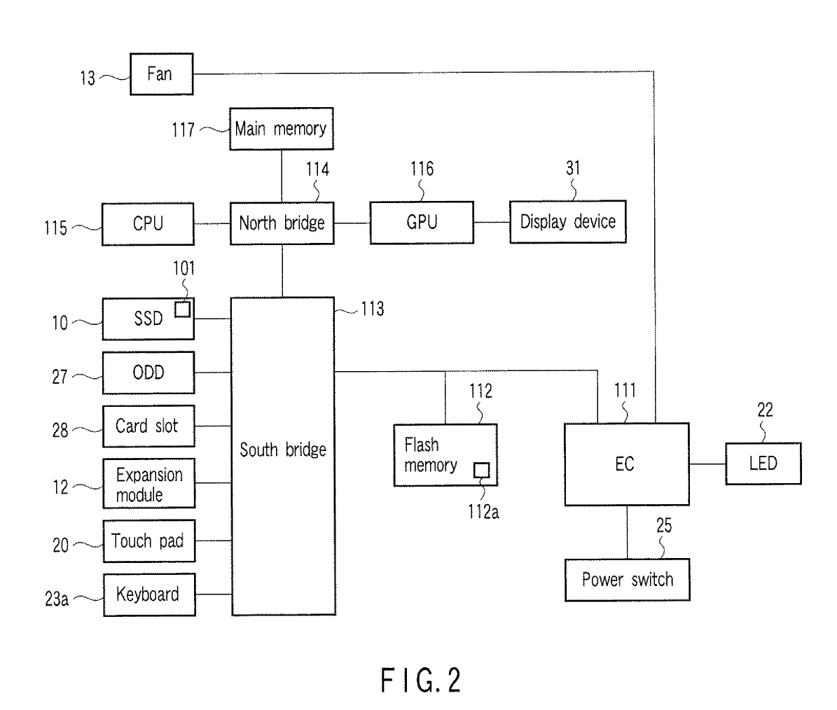

FIG. 2 is a block diagram which schematically shows the structure of the information processing apparatus according to the embodiment of the present invention.

This information processing apparatus 1, as shown in FIG. 2, includes an EC (Embedded Controller) 111, a flash memory 112 which stores a BIOS (Basic Input Output System) 112a, a south bridge 113, a north bridge 114, a CPU (Central Processing Unit) 115, a GPU (Graphic Processing Unit) 116 and a main memory 117, in addition to the above-described SSD 10, expansion module 12, fan 13, touch pad 20, LED 22, keyboard 23a, power switch 25, ODD 27, card slot 28 and display device 31.

The EC (Embedded Controller) 111 is a built-in system which controls the respective parts. The north bridge 114 is an LSI which controls connection between the CPU 115, GPU 116, main memory 117 and various buses. The CPU 15 is a processor which performs arithmetic processing of various signals, and executes an operating system and various application programs, which are loaded from the SSD 10 into the main memory 117. The GPU 116 is a display controller which executes display control by performing arithmetic processing of a video signal.

The expansion module 12 includes an expansion circuit board, a card socket which is provided on the expansion circuit board, and an expansion module board which is Inserted in the card socket. The card socket supports, e.g. the Mini-PCI standard. Examples of the expansion module board include a 3G (3rd Generation) module, a TV tuner, a GPS module, and a Wimax (trademark) module.

The fan 13 is a cooling unit which cools the inside of the casing 4 on the basis of air feeding, and exhausts the air in the casing 4 to the outside as the wind W via the exhaust port 29.

The EC 111, flash memory 112, south bridge 113, north bridge 114, CPU 115, GPU 116 and main memory 117 are electronic components which are mounted on the main circuit board.

The SSD 10 is a drive which, unlike a hard disk drive, does not have a driving mechanism of a magnetic disk, a head, etc., but the SSD 10 can store programs, such as the OS (Operating System), and data which is created by the user or created on the basis of software, in memory areas of a NAND memory, which is a nonvolatile semiconductor memory, for a long time in a readable/writable manner, and can operate as a boot drive of the information processing apparatus 1.

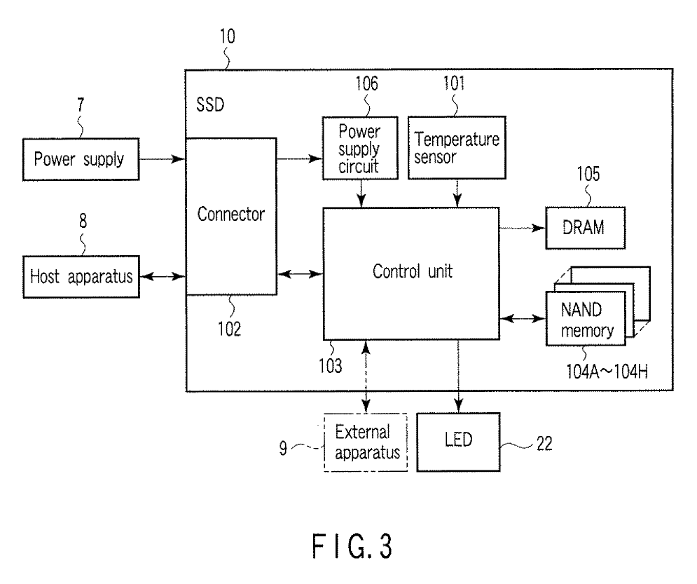

FIG. 3 is a block diagram which schematically shows the structure of the SDD that is used in the present embodiment.

A control unit 103, which functions as a memory controller, is connected to a temperature sensor 101, a connector 102, eight NAND memories 104A to 104H, a DRAM 105 and a power supply circuit 106. In addition, the control unit 103 is connected to the host apparatus 8 via the connector 102, and is connected, where necessary, to an external apparatus 9.

A power supply 7 is the battery pack 24 or an AC adapter (not shown). For example, a power of DC 3.3 V is supplied to the power supply circuit 106 via the connector 102. In addition, the power supply 7 supplies power to the entirety of the information processing apparatus 1.

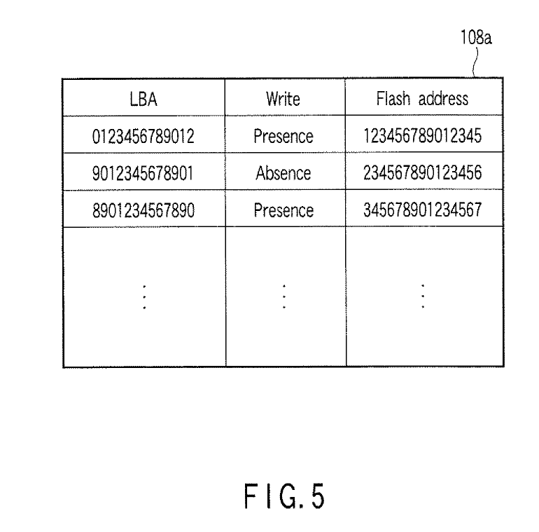

In the present embodiment, the host apparatus 8 is the Information processing apparatus 1, and the south bridge 113, which is mounted on the main circuit board, is connected to the control unit 103. Data transmission/reception is executed between the south bridge 113 and control unit 103, for example, on the basis of the serial ATA standard. In addition, in FIG. 5 which will be described later, the host apparatus 8 is an apparatus which is connected at the time of manufacture of the SSD 10.

The external apparatus 9 is an information processing apparatus which is different from the information processing apparatus 1. The external apparatus 9 is connected to the control unit 103 of the SSD 10 which is removed from the information processing apparatus 1, for example, on the basis of the RS-232C standard, and the external apparatus 9 has a function of reading out data which is stored in the NAND memories 104A to 104H.

The board, on which the SSD 10 is mounted, has the same outside size as an HDD (Hard Disk Drive) of, e.g. 1.8-inch type or 2.5-inch type. In the present embodiment, this board has the same outside size as the 1.8-inch type HDD.

On the board, the temperature sensor 101 is provided between the control unit 103 and the NAND memories 104A to 104H, both of which are heat sources. In the present embodiment, the temperature sensor 101 is provided approximately on a central part of the board in such a manner that the temperature sensor 101 is surrounded by the control unit 103 and the NAND memories 104A to 104H, and the temperature sensor 101 measures the temperature at that position. The measured temperature, which is measured by the temperature sensor 101, is sent to the control unit 103 as temperature information. In this embodiment, use is made of a semiconductor temperature sensor which makes use of such characteristics that the voltage of a PN junction part of a semiconductor varies depending on temperature. However, use may be made of temperature sensors using other methods, such as a thermistor.

The temperature measured by the temperature sensor 101 provided at the above-described position is, e.g. 50° C. to 60° C. in the case where the SSD 10 is in operation, and this temperature is higher than the temperature of the other region of the board by about 10° C.

The control unit 103 is a control module configured to control an operation on the NAND memories 104A to 104H. Specifically, n accordance with a request (read command, write command, etc.) from the host apparatus 8, the control unit 103 controls data read/write on the NAND memories 104A to 104H. The data transfer speed is, for example, 100 MB/Sec at a data read and 40 MB/Sec at a data write.

The control unit 103 acquires temperature information from the temperature sensor 101 at fixed cycles, and lowers the response to the host apparatus 8 when the measured temperature indicated by the temperature information exceeds a preset specified value. The operation of lowering the response is an operation of restricting a part of the processing performance of the SSD 10. Examples of the operation of lowering the response include an operation of decreasing the transfer speed at the time of transferring read data from the NAND memory, 104A to 104H, to the host apparatus 8, and an operation of decreasing the transfer speed between the control unit 103 and the NAND memory, 104A to 104H.

When the measured temperature exceeds the specified value, the control unit 103 outputs an alarm signal to the host apparatus 8 as information to that effect. The control unit 103 may output, instead of the alarm signal, temperature information itself to the host apparatus 8.

In addition, the control unit 103 writes the acquired temperature information, together with the data/time of acquisition, at a predetermined address of the NAND memory, 104A to 104H.

Each of the NAND memories 104A to 104H is a nonvolatile semiconductor memory having a memory capacity of, e.g. 16 GB. Each of the NAND memories 104A to 104H is composed of, e.g. an MLC (Multi-Level Cell)-NAND memory (multilevel NAND memory) in which 2 bits can be recorded in one memory cell. The MLC-NAND memory has such features that the allowable number of rewrites is smaller than an SLC (Single-Level Cell)-NAND memory, but the memory capacity can be increased more easily than the SLC (Single-Level Cell)-NAND memory.

The NAND memories 104A to 104H have such characteristics that the time period, in which data can be retained, varies depending on the temperature of the environment in which they are disposed.

The NAND memory 104A to 104H store data which is written by the control of the control unit 103, and temperature information and the date/time of acquisition of temperature information as the history of temperatures.

The DRAM 105 is a buffer which temporarily stores data when data read/write is executed on the NAND memory, 104A to 104H, by the control of the control unit 103. The DRAM 105 functions as a write cache which temporarily stores write data from the information processing apparatus main body 2 that functions as the host apparatus 8.

The connector 102 has a shape based on, e.g. the serial ATA standard. The control unit 103 and power supply circuit 106 may be connected to the host apparatus 8 and power supply 7 via different connectors.

The power supply circuit 106 converts DOC 3.3 V, which is supplied from the power supply 7, to, e.g. DC 1.8 V and 1.2 V, and supplies these three kinds of voltages to the respective parts in accordance with the driving voltages of the respective parts of the SSD 10.

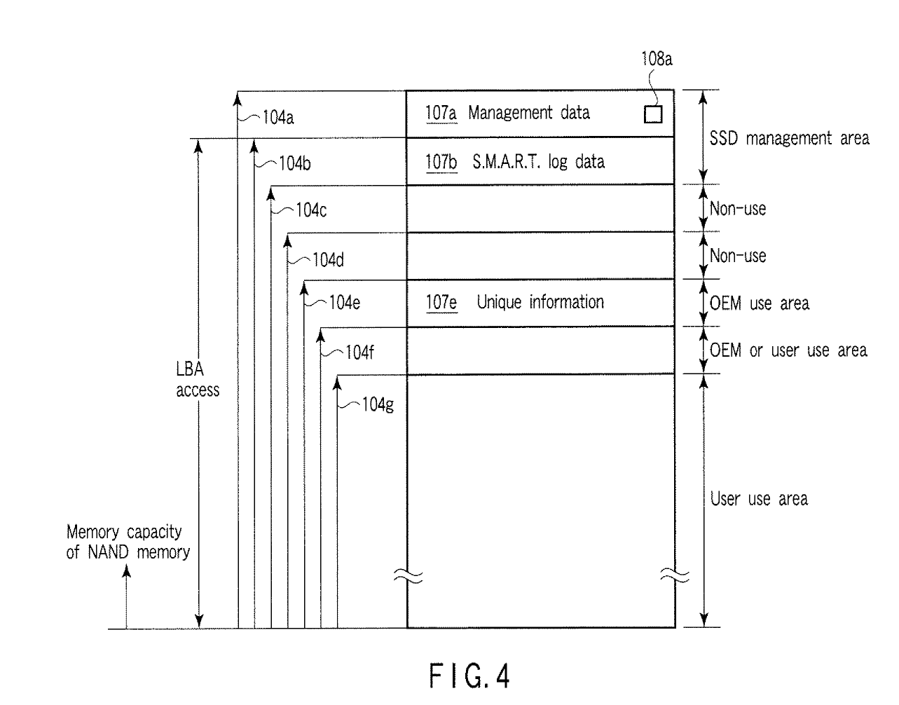

FIG. 4 schematically shows the memory capacities and memory areas of the SSD 10 which Is used in the present embodiment.

The control unit 103 of the SSD 10 manages seven kinds of memory capacities 104a to 104g, which are shown in FIG. 4.

A memory area between the memory capacities 104a and 104b stores management data 107a for operating the SSD 10, and a flash address conversion table 108a for converting logical block addresses LEA to physical addresses (flash addresses) corresponding to sectors which are memory units of the NAND memories 104A to 104H. The flash address conversion table 108a is an address management table which indicates a correspondency between the logical block addresses LBA and the physical addresses of the NAND memories 104A to 104H. Using the flash address conversion table 108a, the control unit 103 controls data write/read on the NAND memories 104A to 104H. Responding to reception of a read request (read command) from the host apparatus 8, the control unit 103 refers to the flash address conversion table 108a. In the case where the physical address corresponding to the logical block address LBA included in the read request is stored in the flash address conversion table 108a, the control unit 103 executes read access to the NAND memories 104A to 104H by using this physical address, and reads data from a predetermined memory location (sector) in the NAND memories 104A to 104H, which is designated by the physical address. On the other hand, in the case where the physical address corresponding to the logical block address LBA is not stored in the flash address conversion table 108a, that is, in the case where logical/physical address conversion information corresponding to the logical block address LBA included in the read request is not stored in the flash address conversion table 108a, the control unit 103 outputs data of a predetermined value to the host apparatus 8 as read data corresponding to the logical block address LBA.

In usual cases, at the time of shipment of the SSD 10, it is necessary to write zero data (00h) in all or a part of the memory area of the SSD 10. This aims at enabling return of an initial value (e.g. 00h) from the SSD 10 to the host in response to a read request from the host. In the NAND memory, all “1” data (FFh) is read from a memory location which is in the erase state. Thus, at the time of shipment of the SSD 10, it is necessary to write zero data (00h) in all or a part of the memory area.

In the present embodiment, in the case where read access to the LBA, whose logical/physical address conversion information is not stored in the flash address conversion table 108a, is requested from the host, as described above, the control unit 103 can return data of a predetermined value, e.g. zero data (00h), to the host apparatus 8 as read data. Accordingly, at the time of shipment of the SSD 10, for example, simply by executing the process of initializing the flash address conversion table 108a and setting the flash address conversion table 108a in the state in which the physical address corresponding to each LBA is not stored in the flash address conversion table 108a, the initial data of a predetermined value, e.g. zero data (00h), can be returned to the host apparatus 8 as read data. It is thus possible to omit a process of writing initial data, i.e. zero data (00h), in all or a part of the memory area of the SSD 10, simply by clearing, from the flash address conversion table 108a, the physical address corresponding to each LBA belonging to a predetermined logical address range, or the physical address corresponding to each LBA belonging to the entire logical address range. As a result, the manufacturing process can be simplified. In addition, since the initial data (e.g. zero data (00h)) of a predetermined value can immediately be returned to the host apparatus 8 without actually executing read access to the NAND memory, the read operation performance can be improved.

In the case where the LBA and physical address are stored in each of the entries of the flash address conversion table 108a,both the LBA and physical address may be cleared in the initializing process of the flash address conversion table 108a. In addition, the flash address conversion table 108a may store, in association with each LBA, flag information which is indicative of the presence/absence of data write in connection with the physical address corresponding to the logical block address. In this case, in the initializing process of the flash address conversion table 108a, the control unit 103 may set flag information corresponding to each LBA at a value indicative of the absence of write. In the case where the flag information corresponding to the LBA included in the read command from the host apparatus 8 is indicative of the absence of write, the control unit 103 determines that the physical address corresponding to the LBA included in the read request is not stored in the flash address conversion table 108a, and outputs the initial data of the predetermined value to the host apparatus 8.

The memory area between the memory capacities 104b and 104c stores S.M.A.R.T. (Self-Monitoring Analysis and Reporting Technology) log data 107b as memory inspection history information which is statistical information such as the above-described temperature information.

A non-use memory area having a memory capacity of, e.g. 2 MB is set in the memory area between the memory capacities 104c and 104d. The reason for this is that the minimum memory unit of the LBA is 8 sectors, which is a memory unit corresponding to 4 KB (a large memory unit is 1 MB), whereas the actual minimum recording unit of data is 1 sector as a matter of course, and thus the S.M.A.R.T. log data 107b and the data recorded in the memory area equal to or lower than the memory capacity 104d are independently handled by providing an empty memory area with a memory capacity of 1 MB or more.

The memory area between the memory capacities 104d and 104e is a non-use area, and the memory capacity 104d and 104e have the same value except for a particular case.

The memory area between the memory capacities 104e and 104f is a memory area which is used by the OEM. As described above, the unique information, which is determined by the request of the OEM, is written in this memory area.

The memory area between the memory capacities 104f and 104g is a memory area which is used by the OEM or the user. Data write is executed in this memory area by the setting of the OEM or user.

The memory area of the memory capacity 104g is a memory area which is used by the user, and data write is executed in this memory area by the setting of the user.

FIG. 5 shows an example of the structure of the flash address conversion table which is used in the present embodiment.

The flash address conversion table 108a, as described above, is a table for associating the LBA and flash address. In the flash address conversion table 108a, there is provided a “writer” flag field which indicates, for example, whether data (e.g. effective data such as the above-described initial data of the predetermined value) is written at the flash address which is associated with each LBA. In this “write” flag field, “presence” or “absence” is described by the control unit 103. The “presence” indicates that data write is executed at the flash address which is associated with the corresponding LBA, and the “absence” indicates no data write. The value of the “write” flag field is changed from “absence” to “presence” if a write operation is executed. In addition, by executing the process of initializing the SSD 10, for example, the values of all “write” flag fields are changed to “absence”.

<Operation>

The operation of the information processing apparatus 1 according to the present embodiment will now be described with reference to the drawings.

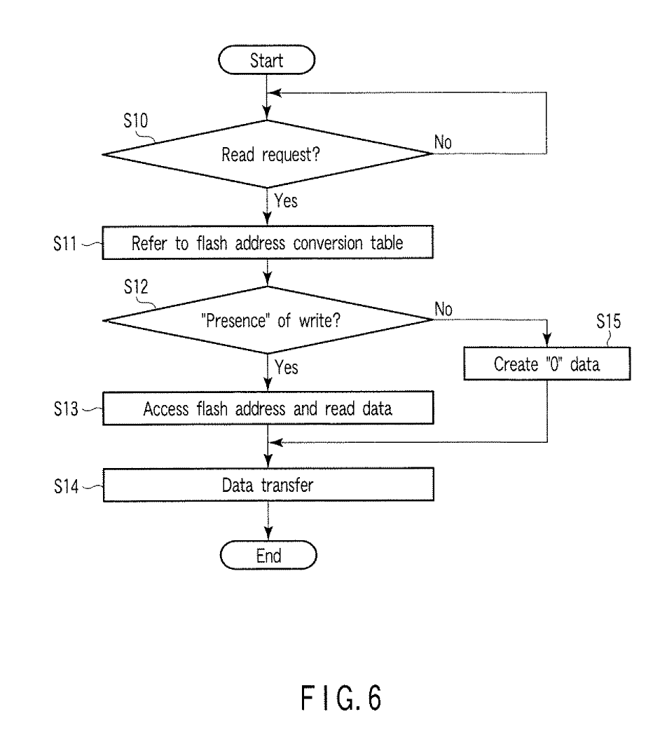

FIG. 6 is a flow chart illustrating the operation of the SSD 10 which is used in the present embodiment.

Upon receiving a read request (read command) from the host apparatus 8 (Yes in step S1), the control unit 103 refers to the flash address conversion table 108a (step S11).

If the “write” flag field corresponding to the LBA, which is included in the read request, indicates “presence” (Yes in step S12), the control unit 103 acquires the flash address, which corresponds to the LBA included in the read request, from the flash address conversion table 108a, and executes read access to the NAND memories 104A to 104H by using the acquired flash address (step S13). In step S13, data stored in a memory location (sector) in the NAND memories 104A to 104H, which is designated by the flash address, is read. The data, which is read from the NAND memories 104A to 104H, is sent to the host apparatus 8 (step S14).

On the other hand, if the “write” flag field corresponding to the LBA, which is included in the read request, indicates “absence”, or if the flash address corresponding to the LBA, which is included in the read request, is not stored in the flash address conversion table 108a (No in step S12), the control unit 103 creates zero data as an initial value (step S15). Subsequently, the control unit 103 sends the zero data to the host apparatus 8 as read data (step S14).

As has been described above, according to the present embodiment, in the case where a read request is issued from the host apparatus 8 with respect to the LBA corresponding to the flash address at which no data write is executed, zero data, which is the initial value, is sent, as a response, to the host apparatus 8. Therefore, the step of the initializing process is needless at the time of manufacture.

In addition, since data read is not executed with respect to the flash address at which no data is written, the read performance of the SSD 10 is improved, compared to the case of executing data read from all flash addresses, regardless of the presence/absence of data write.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an information processing apparatus main body; and
a nonvolatile semiconductor memory drive which is accommodated in the information processing apparatus main body, the nonvolatile semiconductor memory drive including a nonvolatile semiconductor memory, an address management table which is indicative of a correspondency between logical block addresses and physical addresses of the nonvolatile semiconductor memory, and a control module, the control module referring to the address management table in response to reception of a read request from the information processing apparatus main body, and outputting data of a predetermined value to the information processing apparatus main body in a case where the physical address corresponding to the logical block address, which is included in the read request, is not stored in the address management table.

2. The information processing apparatus of claim 1, wherein in a case where the physical address corresponding to the logical block address, which is included in the read request, is stored in the address management table, the control module executes read access to the nonvolatile memory by using the physical address.

3. The information processing apparatus of claim 1, wherein the address management table stores, in association with each logical block address, flag information which is indicative of presence/absence of write of data in connection with the physical address corresponding to the logical block address, and in a case where the flag information corresponding to the logical block address included in the read request is indicative of absence of writer the control module determines that the physical address corresponding to the logical block address included in the read request is not stored in the address management table, and outputs the data of the predetermined value to the information processing apparatus main body.

4. The information processing apparatus of claim 1, wherein the data of the predetermined value is zero data.

5. A nonvolatile semiconductor memory drive which is used as an external storage device of an information processing apparatus, comprising:
a nonvolatile semiconductor memory;
an address management table which is indicative of a correspondency between logical block addresses and physical addresses of the nonvolatile semiconductor memory; and
a control module configured to refer to the address management table in response to reception of a read request from the information processing apparatus main body, and to output data of a predetermined value to the information processing apparatus main body in a case where the physical address corresponding to the logical block address, which is included in the read request, is not stored in the address management table.

6. The nonvolatile semiconductor memory drive of claim 5, wherein in a case where the physical address corresponding to the logical block address, which is included in the read request, is stored in the address management table, the control module executes read access to the nonvolatile memory by using the physical address.

7. The nonvolatile semiconductor memory drive of claim 5, wherein the address management table stores, in association with each logical block address, flag information which is indicative of presence/absence of write of data in connection with the physical address corresponding to the logical block address, and in a case where the flag information corresponding to the logical block address included in the read request is indicative of absence of write, the control module determines that the physical address corresponding to the logical block address included in the read request is not stored in the address management table, and outputs the data of the data of the predetermined value to the information processing apparatus main body.
